(19) United States
(12) Patent Application Publication
(10) Pub. No.: US 2026/0270183 A1
(43) Pub. Date: Sep. 10, 2026

(54) DETERMINING TRACEROUTE OF AN EXISTING TCP FLOW

(71) Applicant: Charter Communications Operating, LLC, St. Louis, MO (US)

(72) Inventor: Robert B. Hulshof, Highlands Ranch, CO (US)

(73) Assignee: Charter Communications Operating, LLC, St. Louis, MO (US)

(21) Appl. No.: 19/074,779

(22) Filed: Mar. 10, 2025

(51) Int. Cl. H04L 43/106; H04L 43/026

(52) U.S. Cl. CPC H04L 43/106; H04L 43/026

(57) ABSTRACT

To determine a path traceroute for an existing (e.g., TCP) flow, a path node (e.g., the flow's source node) transmits towards the flow's destination node a set of traceroute packets having different time-to-live (TTL) values and the same payload as the payload in a captured, existing flow packet so that the destination node will drop (large-TTL) traceroute packets having duplicate payloads. The traceroute is determined from timeout packets received from hops that received expired (i.e., small-TTL) traceroute packets.

### BACKGROUND

### Field of the Disclosure

The present disclosure relates to communication networks and, more specifically but not exclusively, to techniques for determining traceroutes of paths in communication networks.

### Description of the Related Art

This section introduces aspects that may help facilitate a better understanding of the disclosure. Accordingly, the statements of this section are to be read in this light and are not to be understood as admissions about what is prior art or what is not prior art.

The term “traceroute” refers to the sequence of hops (i.e., intermediate nodes) through which packets flow in a path from a source node to a destination node in a communication network. The determination of traceroutes enables pinpointing which hop or hops cause excessive latencies, which information may be useful in managing network data flows. The typical method to trace a network path is to send a sequence of traceroute packets (also referred to as echo or ping packets) from the source node towards the destination node with each traceroute packet having a different time-to-live (TTL) value and a unique sequence number in its Internet Protocol (IP) header.

As known to those skilled in the art, as a packet traverses a hop, the hop will decrement the TTL value in the packet's IP header. A hop that receives a packet having a TTL value of 1 (one) will not forward the packet towards the destination node, but will instead transmit a “timeout” packet back to the source node identifying that hop and the received packet's unique sequence number in the IP header of the timeout packet in order to inform the source node that its transmitted packet never reached the destination node.

By transmitting, along a particular path, a sequence of traceroute packets having TTL values of 1, 2, 3, etc., respectively, up to a TTL value larger than the expected maximum number of hops in the network's paths, the source node will be able to determine the particular path's traceroute by keeping track of the hops that transmitted timeout packets in response to different traceroute packets.

### SUMMARY

One typical method for determining traceroutes is to use traceroute packets that conform to the Internet Control Message Protocol (ICMP). ICMP packets are sometimes routed differently from packets that conform to the Transmission Control Protocol (TCP). As such, it is also useful to implement the traceroute technique using TCP packets in order to determine a more-representative network path for routine TCP data packets.

An existing TCP flow of packets from a source node to a destination node associated with a particular application may begin to experience latency problems. In such a situation, it would be helpful to determine the traceroute for the existing TCP flow in order to identify the hop or hops that are causing the latency problem. Unfortunately, in modern communication networks, there may be multiple ways to route a TCP packet from the source node to the destination node. As such, TCP traceroute packets transmitted from the source node towards the destination node may follow a path that is different from the path of the existing TCP flow and may even follow paths that are different from one another.

To address this problem, an embodiment of the present disclosure captures the 5-tuple for the existing TCP flow and generates TCP traceroute packets based on that same 5-tuple to ensure that the TCP traceroute packets follow the same path as the existing TCP flow. As understood by those skilled in the art, the 5-tuple for a TCP flow is a set of five pieces of information that uniquely defines the path of the existing TCP flow, where the 5-tuple consists of the source and destination Internet Protocol (IP) addresses, the source and destination port numbers, and the transmission protocol of the flow, all of which are encoded into each packet of the existing flow.

In some implementations, the 5-tuple is extracted from one of the actual packets of the existing TCP flow and used to generate the TCP traceroute packets, all of which have copies of the payload of that flow packet. For those TCP traceroute packets that expire before they reach the destination node (i.e., TCP traceroute packets having insufficiently large, initial TTL values), the hops at which they expire will transmit timeout packets back to the source node. For those TCP traceroute packets that reach the destination node (i.e., TCP traceroute packets having sufficiently large, initial TTL values), the destination node will drop those packets as duplicates of the earlier, actual packet of the existing TCP flow due to their identical payloads. In this way, the source node will be able to determine the traceroute for the existing TCP flow from the received timeout packets corresponding to the small-TTL traceroute packets.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a path of an existing TCP flow in a communication network, according to certain embodiments of the present disclosure; and

FIG. 2 is a simplified hardware block diagram of an example node that can be used to implement any of the nodes of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

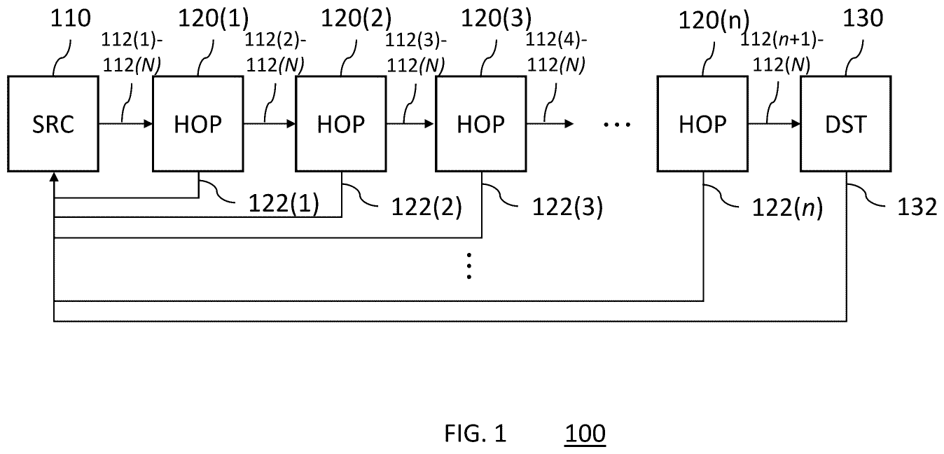

FIG. 1 is a block diagram of a path 100 of an existing TCP flow in a communication network, according to certain embodiments of the present disclosure. As shown in FIG. 1, the path 100 comprises a source node (SRC) 110 connected to a destination node (DST) 130 via a set of n intermediate nodes (hops) 120(1)-120(n).

The process of determining the traceroute of path 100 can, in theory, be initiated at the source node 110 or at any of the hops 120(1)-120(n). If the process is initiated at a hop 120, then the traceroute for the entire path 100 might not be determined. The following discussion assumes that the process is initiated at the source node 110.

To determine the traceroute of the path 100, the source node 110 captures an application flow packet (i.e., an actual packet of the existing TCP flow) and extracts the 5-tuple for the flow from the packet's TCP data (i.e., header and payload).

The source node 110 transmits towards the destination node 130 along the path 100 a set of TCP data packets 112(1)-112(N), as TCP traceroute packets, having (i) corresponding TTL values of 1-N, respectively, and (ii) the same payload as the captured application flow packet, where the number N of TCP data packets 112 is greater than the expected number n of hops 120 in the path 100. Note that the source node 110 can transmit those N TCP data packets 112 in any order and with any relative timing.

In particular, the set of N TCP data packets 112(1)-112(N) includes:
A TCP data packet 112(1) having an initial TTL value of 1 and the same payload as the captured application flow packet;
A TCP data packet 112(2) having an initial TTL value of 2 and the same payload;
A TCP data packet 112(3) having an initial TTL value of 3 and the same payload; and
And so on up to a TCP data packet 112(N) having an initial TTL value of N and the same payload.

When the TCP data packet 112(1) arrives at the hop 120(1), the hop 120(1) will determine that the TTL value is 1, drop the first TCP data packet 112(1), and transmit back to the source node 110 an ICMP timeout packet 122(1) identifying the hop 120(1) and the TCP data packet 112(1). Note that the path traversed by the timeout packet 122(1) may be different from the path 100.

When the TCP data packet 112(2) arrives at the hop 120(1), the hop 120(1) will determine that the TTL value is 2, decrement the TTL value to 1, and forward the TCP data packet 112(2) to the hop 120(2).

When the TCP data packet 112(2) arrives at the hop 120(2), the hop 120(2) will determine that the TTL value is 1, drop the TCP data packet 112(2), and transmit back to the source node 110 an ICMP timeout packet 122(2) identifying the hop 120(2) and the TCP data packet 112(2). Note that the path traversed by the timeout packet 122(2) may be different from the path 100 and/or different from the path traversed by the other timeout packet 122.

When the TCP data packet 112(3) arrives at the hop 120(1), the hop 120(1) will determine that the TTL value is 3, decrement the TTL value to 2, and forward the TCP data packet 112(3) to the hop 120(2).

When the TCP data packet 112(3) arrives at the hop 120(2), the hop 120(2) will determine that the TTL value is 2, decrement the TTL value to 1, and forward the TCP data packet 112(3) to the hop 120(3).

When the TCP data packet 112(3) arrives at the hop 120(3), the hop 120(3) will determine that the TTL value is 1, drop the TCP data packet 112(3), and transmit back to the source node 110 an ICMP timeout packet 122(3) identifying the hop 120(3) and the TCP data packet 112(3). Note that the path traversed by the timeout packet 122(3) may be different from the path 100 and/or different from the paths traversed by the other timeout packets 122.

Analogous processing applies to the rest of the TCP data packets 112 up to the TCP data packet 112(n) which leaves the source node 110 with an initial TTL value of n and arrives at the last hop 120(n) with a TTL value of 1. As such, the hop 120(n) will determine that the TTL value is 1, drop the TCP data packet 112(n), and transmit back to the source node 110 an ICMP timeout packet 122(n) identifying the hop 120(n) and the TCP data packet 112(n). Note that the path traversed by the timeout packet 122(n) may be different from the path 100 and/or different from the paths traversed by the other timeout packets 122.

The TCP data packet 112(n+1) leaves the source node 110 with a TTL value of (n+1) and arrives at the destination node 130 with a TTL value of 1. In response, the destination node 130 determines that the payload of the TCP data packet 112(n+1) is a duplicate of the previously received, captured application flow packet and will simply drop (i.e., ignore) the TCP data packet, thereby avoiding sending multiple packets with the same payload to the application.

Similarly, the other (N-n−2) TCP data packets 112 that leave the source node 110 with a TTL value greater than (n+1) will arrive at the destination node 130 with a TTL value greater than 1. Here, too, in response, the destination node 130 will simply drop those packets.

After receiving all n of the ICMP timeout packets 122(1)-122(n), the source node 110 will have all the information needed to determine the traceroute of the path 100, with the exception of the destination node 130. The destination hop-distance can be deduced from a return packet transmitted from the destination node 130 back to the source node 110 for the existing flow.

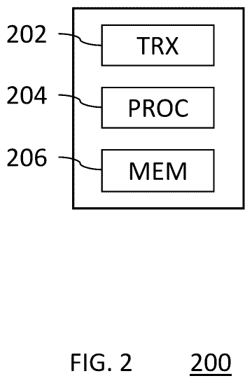

FIG. 2 is a simplified hardware block diagram of an example node 200 that can be used to implement any of the nodes 110, 120, and 130 of FIG. 1. As shown in FIG. 2, the node 200 includes (i) communication hardware (e.g., wireless, wireline, and/or optical transceivers (TRX)) 202 that supports communications with other nodes, (ii) one or more processors (e.g., CPU and/or GPU microprocessors) 204 that control the operations of the node 200 and/or process data within the node 200, and (iii) one or more memories (e.g., RAM, ROM) 206 that store code executed by the processors 204 and/or data generated and/or received by the node 200.

Although the present disclosure has been described in the context of a communication network that supports both TCP and ICMP protocols, where the traceroute packets are TCP data packets and the timeout packets are ICMP timeout packets, those skilled in the art will understand that the disclosure encompasses embodiments in which the communication network supports other suitable transmission protocols.

Although the present disclosure has been described in the context of a set of traceroute packets having the same payload as that of a single captured packet of the existing flow, those skilled in the art will understand that, in general, it is sufficient for each traceroute packet to have the same payload as one of the existing flow packets, even if different traceroute packets have different payloads extracted from different existing flow packets.

In certain embodiments, the present disclosure is an apparatus comprising a path node for determining a traceroute of at least a portion of a path from a source node via a set of one or more hops to a destination node in a communication network. The path node comprises a memory and at least one processor, coupled to the memory and operative to identify the existing flow in the communication network; transmit towards the destination node along the portion of the path a set of traceroute packets having different TTL values and a payload identical to a payload of an existing flow packet of the existing flow; receive, from each hop in the portion of the path, a timeout packet identifying the hop and a corresponding traceroute packet; and determine the traceroute from the one or more timeout packets.

In at least some of the above embodiments, the communication network supports TCP; and each traceroute packet is a TCP data packet.

In at least some of the above embodiments, each timeout packet is an ICMP timeout packet.

In at least some of the above embodiments, the existing flow is identified by a 5-tuple extracted from the existing flow packet.

In at least some of the above embodiments, the path node extracts the 5-tuple from the existing flow packet.

In at least some of the above embodiments, the path node is the source node and the traceroute is for the entire path.

In at least some of the above embodiments, the path node is a hop in the set and the traceroute is for the portion of the path downstream of the hop.

In at least some of the above embodiments, the apparatus comprises the source and destination nodes and the hops.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for determining a traceroute of at least a portion of a path of an existing flow from a source node via a set of one or more hops to a destination node in a communication network, the method comprising a path node:
identifying the existing flow in the communication network;
transmitting towards the destination node along the portion of the path a set of traceroute packets having different time-to-live (TTL) values and a payload identical to a payload of an existing flow packet of the existing flow;
receiving, from each hop in the portion of the path, a timeout packet identifying the hop and a corresponding traceroute packet; and
determining the traceroute from the one or more timeout packets.

2. The method of claim 1, wherein:
the communication network supports Transport Control Protocol (TCP); and
each traceroute packet is a TCP data packet.

3. The method of claim 2, wherein each timeout packet is an Internet Control Message Protocol (ICMP) timeout packet.

4. The method of claim 1, wherein the existing flow is identified by a 5-tuple extracted from the existing flow packet.

5. The method of claim 4, wherein the path node extracts the 5-tuple from the existing flow packet.

6. The method of claim 1, wherein the path node is the source node and the traceroute is for the entire path.

7. The method of claim 1, wherein the path node is a hop in the set and the traceroute is for the portion of the path downstream of the hop.

8. Apparatus comprising a path node for determining a traceroute of at least a portion of a path of an existing flow from a source node via a set of one or more hops to a destination node in a communication network, the path node comprising:
a memory; and
at least one processor, coupled to the memory and operative to:
identify the existing flow in the communication network;
transmit towards the destination node along the portion of the path a set of traceroute packets having different TTL values and a payload identical to a payload of an existing flow packet of the existing flow;
receive, from each hop in the portion of the path, a timeout packet identifying the hop and a corresponding traceroute packet; and
determine the traceroute from the one or more timeout packets.

9. The apparatus of claim 8, wherein:
the communication network supports TCP; and
each traceroute packet is a TCP data packet.

10. The apparatus of claim 9, wherein each timeout packet is an ICMP timeout packet.

11. The apparatus of claim 8, wherein the existing flow is identified by a 5-tuple extracted from the existing flow packet.

12. The apparatus of claim 11, wherein the path node extracts the 5-tuple from the existing flow packet.

13. The apparatus of claim 8, wherein the path node is the source node and the traceroute is for the entire path.

14. The apparatus of claim 8, wherein the path node is a hop in the set and the traceroute is for the portion of the path downstream of the hop.

15. The apparatus of claim 8, wherein the apparatus comprises the source and destination nodes and the hops.
